(19) United States
(12) Patent Application Publication
(10) Pub. No.: US 2026/0070495 A1
(43) Pub. Date: Mar. 12, 2026

(54) FIXING STRUCTURE OF DISPLAY ASSEMBLY TO INSTRUMENT PANEL BASE OF VEHICLE, AND VEHICLE

(71) Applicant: Isuzu Motors Limited, Yokohama-shi, Kanagawa (JP)

(72) Inventors: Hitoshi KOMATA, Fujisawa-shi (JP); Changwook AN, Fujisawa-shi (JP)

(73) Assignee: Isuzu Motors Limited, Yokohama-shi, Kanagawa (JP)

(21) Appl. No.: 19/281,836

(22) Filed: Jul. 28, 2025

(30) Foreign Application Priority Data
Sep. 9, 2024 (JP) 2024-154930

(51) Int. Cl. B60R 11/02; B60R 11/00

(52) U.S. Cl. CPC B60R 11/0235; B60R 2011/0005; B60R 2011/0047

(57) ABSTRACT

A fixing structure of a display assembly to an instrument panel of a vehicle, includes: an instrument panel base of the vehicle as a vehicle frame; one or more first brackets including: a first portion to which a back surface of the display assembly having a display section whose screen is disposed toward an interior side of a cab of the vehicle is fixed, and a second portion extending from the first portion to a front side of the vehicle and fastened to the instrument panel base with an external thread; and an internal thread portion that fixes the one or more first brackets to the instrument panel base with the external thread.

### CROSS REFERENCE TO RELATED APPLICATIONS

This application is based upon and claims the benefit of priority from prior Japanese Patent Application No. 2024-154930, filed Sep. 9, 2024, the entire contents of which are incorporated herein by reference.

### FIELD

The present invention relates generally to a fixing structure of a display assembly to an instrument panel base of a vehicle, and a vehicle with the fixing structure.

### BACKGROUND

A display assembly fixed to an instrument panel base of a vehicle has been increased in size. Therefore, the display assembly has an appropriate weight.

For example, Jpn. Pat. Appln. KOKAI Publication No. 2017-81457, Jpn. Pat. Appln. KOKAI Publication No. 2023-169686, and Jpn. Pat. Appln. KOKAI Publication No. 2001-347895 disclose mounting structures of in-vehicle devices.

For example, in a case where the vehicle collides from a rear side of the vehicle and an impact is applied to the vehicle, the impact is transmitted to a beam extending in a right-left direction to a front portion of the vehicle via, for example, a left-right structure of the vehicle. Then, since the instrument panel base is fixed to the beam by bolts or the like, the impact is also transmitted to the instrument panel base. At this time, there is a possibility that the display assembly fixed to the instrument panel base moves toward an occupant side due to inertia.

### SUMMARY

According to an aspect of the invention, A fixing structure of a display assembly to an instrument panel of a vehicle, includes: an instrument panel base of the vehicle as a vehicle frame; one or more first brackets including: a first portion to which a back surface of the display assembly having a display section whose screen is disposed toward an interior side of a cab of the vehicle is fixed, and a second portion extending from the first portion to a front side of the vehicle and fastened to the instrument panel base with an external thread; and an internal thread portion that fixes the one or more first brackets to the instrument panel base with the external thread.

### BRIEF DESCRIPTION OF DRAWINGS

FIG. 1 is a schematic view illustrating a part of a front portion of a vehicle according to an embodiment.

FIG. 2 is a schematic perspective view of a display assembly as viewed from a back side of the display assembly.

FIG. 3 is a schematic view of a fixing structure of the display assembly as viewed from a cab side and from above.

FIG. 4 is a schematic view of the fixing structure of the display assembly as viewed from the cab side and from an upper left side with respect to FIG. 3.

FIG. 5 is a schematic cross-sectional view taken along line V-V in FIG. 1.

FIG. 6 is an enlarged view of a part of FIG. 5.

### DETAILED DESCRIPTION

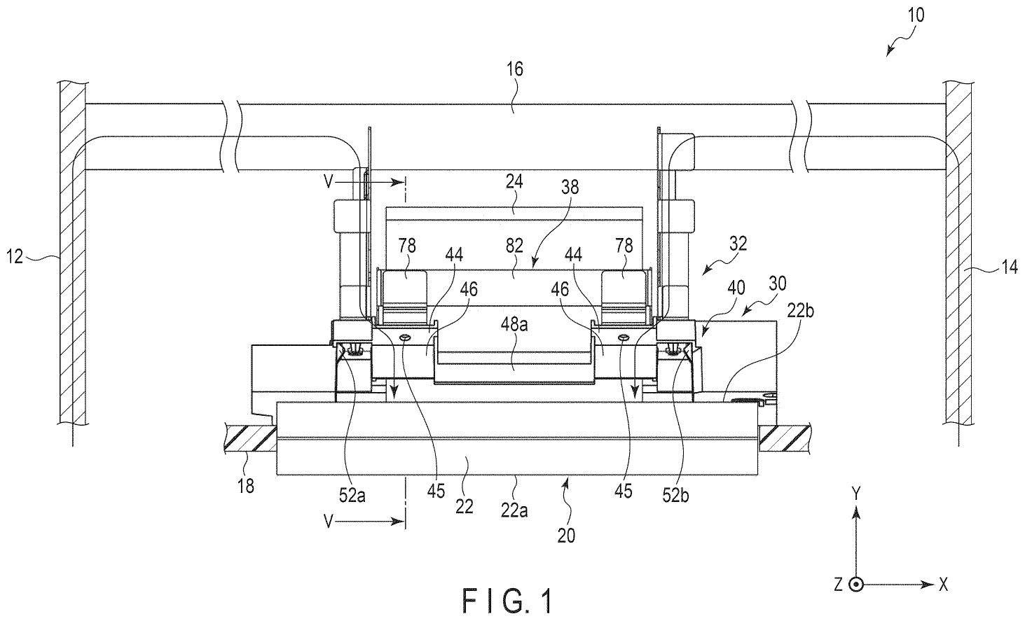

A fixing structure 30 of a display assembly 20 to be fixed to an instrument panel section (decorative panel section) 18 of a vehicle 10 according to an embodiment of the present invention will be described with reference to FIGS. 1 to 6.

FIG. 1 is a schematic view of a front side of the vehicle 10 as viewed from an upper side (roof side) of the vehicle 10. In FIG. 1, a plurality of first brackets 34 and external threads 90 are not illustrated.

An XYZ orthogonal coordinate system is given in FIG. 1. An upper side in a plane of drawing of FIG. 1 is a front side along a +Y-axis direction of the vehicle 10, a right side is a right side along a +X-axis direction of the vehicle 10, a left side is a left side along a −X-axis direction of the vehicle 10, and a lower side is a rear side along a −Y-axis direction of the vehicle 10. Note that, in the vehicle 10 in FIG. 1, portions used for description in the embodiment are illustrated, and illustration of other portions is omitted.

Note that the vehicle 10 here may be a so-called engine vehicle, or may be any of an electric vehicle (EV), a hybrid electric vehicle (HEV), a plug-in hybrid vehicle (PHV), a fuel cell vehicle (FCV), or the like.

As illustrated in FIG. 1, the vehicle 10 includes, for example, a left-side member 12, a right-side member 14, and a tubular beam 16 connecting the left-side member 12 and the right-side member 14 on the front side of the vehicle 10. The beam 16 is fixed to the left-side member 12 and the right-side member 14 with bolts or the like (not illustrated). The beam 16 may have a circular tubular shape or an appropriate polygonal tubular shape. Note that the instrument panel section 18 is disposed on the rear side (cab side) with respect to the beam 16.

Therefore, the fixing structure 30 of the display assembly 20 is fixed to the beam 16 on the cab side (rear side) with respect to the beam 16. Then, the display assembly 20 that can be visually recognized by an occupant of the vehicle 10 is fixed to the fixing structure 30. Note that, in the present embodiment, the display assembly 20 is described as being disposed at a center of the instrument panel section 18 in a width direction, but may be disposed to be shifted to the right or to be shifted to the left.

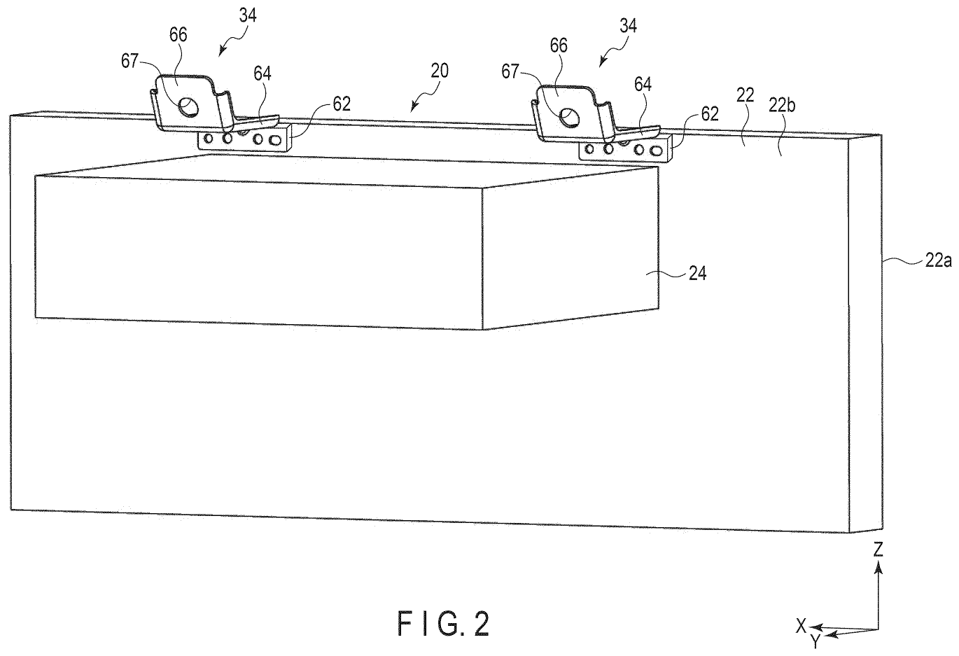

Here, FIG. 2 is a schematic perspective view of the display assembly 20 as viewed from a back side of the display assembly 20. In FIG. 2, illustration of the external threads for fixing a plurality (two) of the first brackets 34 to a back (back surface) 22b of a display section 22 is omitted.

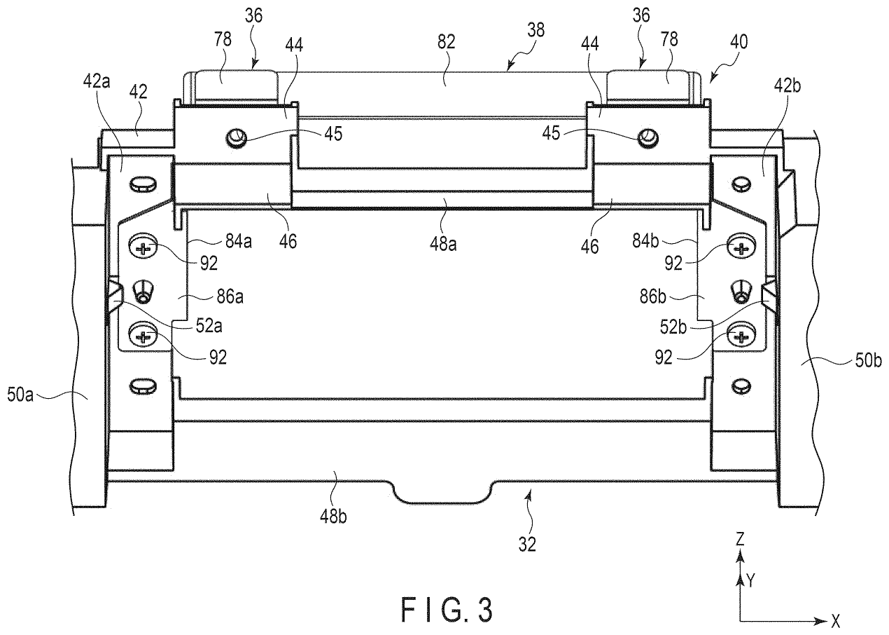

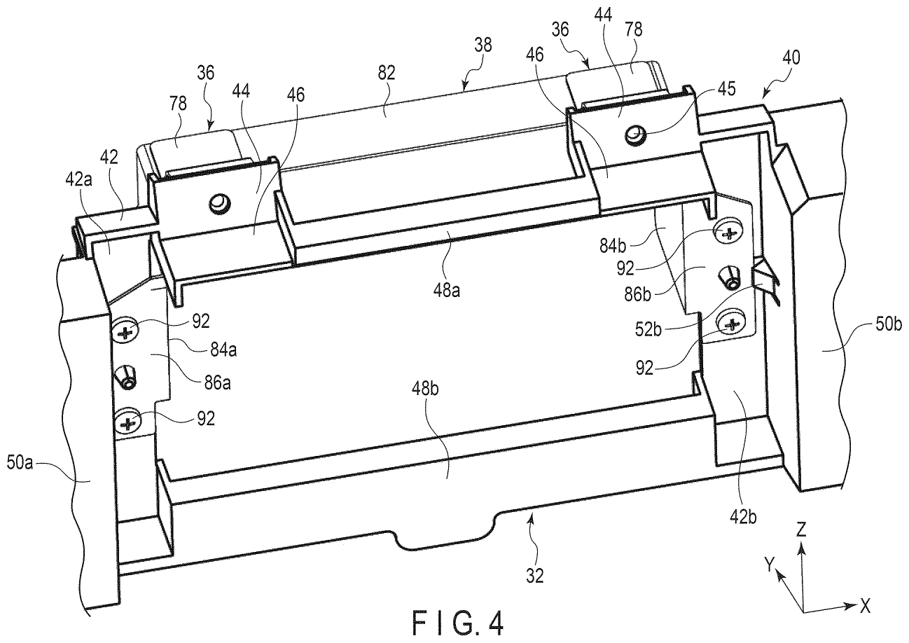

FIG. 3 is a schematic view of the fixing structure 30 of display assembly 20 as viewed from the cab side and from above. FIG. 4 is a schematic view of the fixing structure 30 of the display assembly 20 as viewed from the cab side and from an upper left side with respect to FIG. 3.

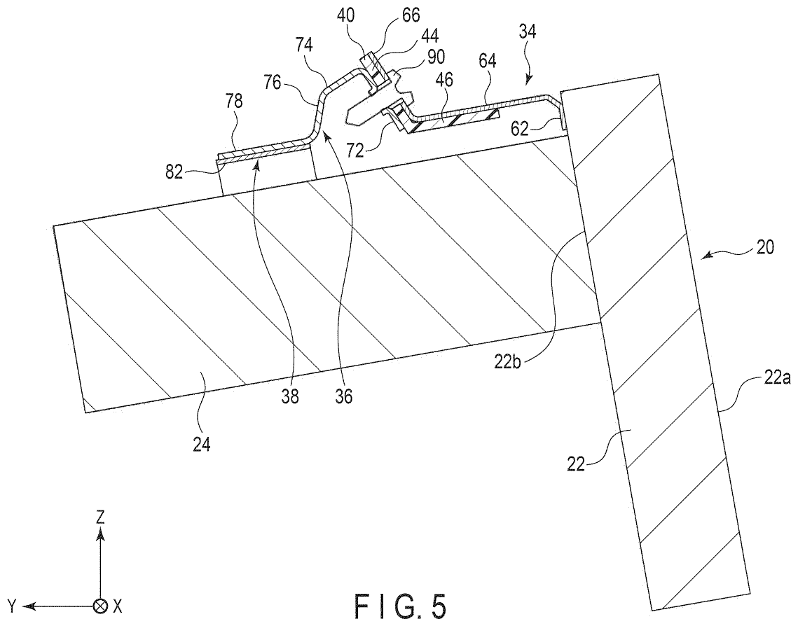

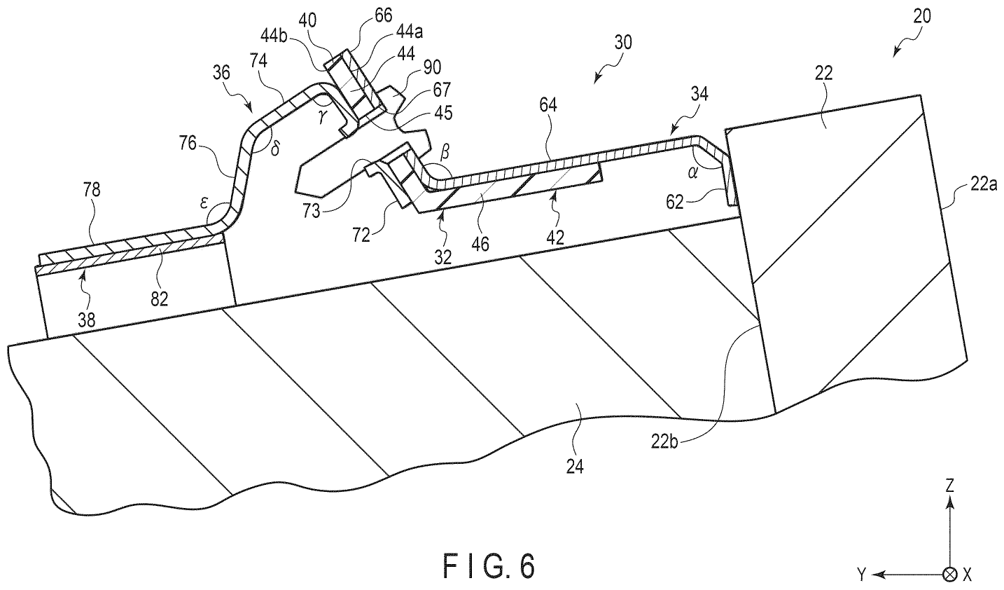

FIG. 5 is a schematic cross-sectional view taken along line V-V in FIG. 1. FIG. 6 is an enlarged view of a part of FIG. 5.

As illustrated in FIGS. 1 and 2, the display assembly 20 includes a display section 22 having a display screen 22a and a housing section 24 provided on the back 22b side of the display section 22. In the present embodiment, it is assumed that the display section 22 is formed in such a size that the housing section 24 is hidden and cannot be visually recognized in a case where the display assembly 20 is viewed from the display screen 22a side.

In the display assembly 20, the display screen 22a faces the cab side (rear side) with respect to the vehicle 10, and the housing section 24 is disposed on the front side with respect to the display section 22. Assuming that the display screen 22a is a flat surface, a normal direction of the display screen 22a preferably faces the rear side and upward with respect to a horizontal direction.

As illustrated in FIG. 2, for example, the plurality of (for example, two) first brackets 34 to be described below are provided on, for example, an upper portion of the back 22b of the display section 22 on a side opposite to the display screen 22a in the display section 22, and are fixed to be separated from each other in a right-left direction. Therefore, an upper side of the display section 22 is fixed to an instrument panel base 32 on the vehicle 10 side at a plurality of points (for example, two points) separated from each other in the right-left direction. The position to which the first bracket 34 is fixed is preferably an upper portion of the back 22b of the display section 22, or may be a left-side and/or a right-side edge of the display section 22 instead of the back 22b of the display section 22 illustrated in FIG. 2.

The fixing structure 30 of the display assembly 20 illustrated in FIGS. 1 to 4 includes the instrument panel base (hereinafter mainly referred to as an IP base) 32, the plurality of first brackets 34, a plurality of second brackets 36, and a frame member 38.

A front end of the IP base 32 is fixed to the beam 16 with bolts (not illustrated). The IP base 32 extends from the beam 16 toward the rear side (cab side). Then, the IP base 32 includes a frame (vehicle-side frame) 40 having, for example, a rectangular frame shape to which the housing section 24 of the display assembly 20 is fitted.

The frame 40 includes a rectangular frame (annular frame) 42, a pedestal 44 of the first bracket 34 and the second bracket 36 provided on an upper portion of the rectangular frame 42, an extension plate 46 extending from the pedestal 44 to the rear side (cab side), an upper protrusion 48a that connects the pedestals 44 and protrudes to the rear side, a lower protrusion 48b that connects a lower portion of the rectangular frame 42 and protrudes to the rear side, and protrusions 50a and 50b protruding to the rear side from a left portion and a right portion of the rectangular frame 42.

As illustrated in FIGS. 3 and 4, the rectangular frame 42 is preferably formed as, for example, an annular body. The rectangular frame 42 is preferably integrally formed using a resin material, for example.

The IP base 32 includes an opening through which the housing section 24 on the back (back surface) 22b side of the display assembly 20 is inserted. The opening is formed by, for example, flat portions 42a and 42b to be described below of the rectangular frame 42, the extension plate 46, the upper protrusion 48a, and the lower protrusion 48b. The housing section 24 of the display assembly 20 is disposed in the opening of the IP base 32.

As illustrated in FIGS. 5 and 6, the pedestal 44 includes a first fixing surface 44a for fixing a first-third portion 66 to be described below of the first bracket 34, and a second fixing surface 44b for fixing the second bracket 36. The normal direction of the first fixing surface 44a faces the cab side (−Y-axis direction and +Z-axis direction) and faces upward with respect to the upper end of the display section 22. The normal direction of the second fixing surface 44b faces an opposite side to the normal direction of the first fixing surface 44a, that is, faces the front side and faces downward with respect to the horizontal direction.

As illustrated in FIGS. 3 to 6, the extension plate 46 supports a first-second portion 64 of the first bracket 34, which will be described below.

As illustrated in FIGS. 3 and 4, the protrusions 48a and 48b and the protrusion 50a are separated from each other, and the protrusions 48a and 48b and the protrusion 50b are separated from each other to form the flat portions 42a and 42b on the rear side of the rectangular frame 42. The protrusions 50a and 50b protrude toward the cab with respect to the protrusions 48a and 48b. For this reason, assuming that the back 22b of the display section 22 of the display assembly 20 is a flat surface, the back can be brought into contact with the protrusions 50a and 50b that are separated in the right-left direction rather than the protrusions 48a and 48b that are separated in an up-down direction. Meanwhile, it is preferable that the back 22b of the display section 22 of the display assembly 20 is separated toward the cab side with respect to the protrusions 48a and 48b separated in the up-down direction.

Each of the plurality of first brackets 34 illustrated in FIGS. 2, 5, and 6 is formed by, for example, performing a process such as pressing on one metal flat plate. The first bracket 34 includes a first-first portion (first portion) 62 that is fixed to, for example, an upper portion of the back 22b of the display section 22 with a screw (not illustrated), the first-second portion 64 that is integrally formed with the first-first portion 62 and extends from the first-first portion 62 to the front side in a state where the display assembly 20 is fixed to the IP base 32 to be described below, and the first-third portion (second portion) 66 that is integrally formed with the first-second portion 64 and in which the normal direction of a surface opposite to a fixing surface fixed to the IP base 32 faces the cab side and faces upward with respect to the upper end of the display section 22 in a state of being fixed to the IP base 32.

The first-first portion 62 is formed to be in close contact with the back 22b of the display section 22 using a screw (not illustrated). Therefore, the first-first portion 62 is reliably fixed to the back 22b of the display section 22.

The first-second portion 64 is bent by, for example, an angle α with respect to the first-first portion 62 and extends to the front side. The angle α is preferably, for example, 90°.

The first-third portion 66 is bent upward by, for example an angle β with respect to a front end of the first-second portion 64. The angle β depends on the angle at which the first-second portion 64 is inclined with respect to a horizontal plane, but is formed so as to extend to the front side and upward with respect to the front end of the first-second portion 64. The angle β is preferably 90°or more and less than 180°. The angle β is more preferably smaller than 135°.

A through hole (screw hole) 67 fixed to the pedestal 44 of the IP base 32 is formed in the first-third portion 66. Similarly, a through hole (screw hole) 45 through which a body portion and a screw portion of the screw 90 pass is formed in the pedestal 44 of the IP base 32.

A center axis (virtual line) of the through hole 67 in the first-third portion 66 of the first bracket 34 is preferably coaxial with a center line of the through hole 45 in the pedestal 44 and a screw hole (through hole) 73 in a second-first portion 72 to be described below of the second bracket 36. Then, the center axis (virtual line) of the through hole 67 in the first-third portion 66 of the first bracket 34 preferably passes above components of the display assembly 20 without intersecting upper ends of the components of the display assembly 20. Therefore, the bending angle β of the first bracket 34 is set such that the head portion of the screw (fastening member) 90 faces the cab side (rear side), that is, a vehicle interior side, in a state where the first bracket 34 is fixed to the pedestal 44.

Each of the plurality of second brackets 36 illustrated in FIGS. 3 to 6 is formed by, for example, performing a process such as pressing on one metal flat plate. The second bracket 36 is fixed to the second fixing surface 44b on the back side of the pedestal 44 of the IP base 32.

The second bracket 36 includes the second-first portion (third portion) 72, a second-second portion 74 integrally formed with the second-first portion 72, a second-third portion 76 integrally formed with the second-second portion 74, and a second-fourth portion (fourth portion) 78 integrally formed with the second-third portion 76.

The second-first portion 72 has a screw hole 73 fixed to the second fixing surface 44b on the back side of the pedestal 44 of the IP base 32 with the screw 90. An internal thread to which the screw 90 is screwed is cut in an inner peripheral surface of the screw hole 73. A diameter of the screw hole 73 is preferably smaller than the through hole 45 in the pedestal 44 and the through hole 67 in the first-third portion 66.

The second-second portion 74 is bent at an angle γ (for example, about 90°) with respect to the second-first portion 72. Then, the second-second portion 74 extends to the front side and downward with respect to the second-first portion 72.

The second-third portion 76 is bent at an angle δ (for example, about 135°) with respect to the second-second portion 74. Then, the second-third portion 76 extends to the front side and downward with respect to the second-second portion 74. The angle δ is preferably an angle at which a tip end of the screw 90 does not interfere. The angle δ is preferably within a range of 120°or more and 150°or less.

The second-fourth portion 78 is bent at an angle ε (for example, about 110°) with respect to the second-third portion 76. Then, the second-fourth portion 78 extends to the front side and downward with respect to the second-third portion 76. Note that the direction in which the second-fourth portion 78 extends is, for example, a direction parallel to an upper surface of the housing section 24 of the display assembly 20. The angle ε is preferably set such that the direction in which the second-fourth portion 78 extends becomes the direction parallel to the upper surface of the housing section 24 of the display assembly 20, for example.

The frame member 38 illustrated in FIGS. 1 and 3 to 6 is fixed to the second-fourth portion 78 of the second bracket 36 by welding, for example.

As illustrated in FIGS. 3 and 4, the frame member 38 includes a beam (cross member) 82 extending in the right-left direction (horizontal direction), a pair of arms 84a and 84b extending downward and toward the rear side from both ends of the beam 82, and fixing plates 86a and 86b provided on the arms 84a and 84b.

Of the pair of arms 84a and 84b, the fixing plate 86a extending to the left side is provided at an end portion on the rear side of the left arm 84a. The fixing plate 86a is fixed to the flat portion 42a on the rear side of the rectangular frame 42 of the frame 40 from the rear side (the direction from the −Y-axis direction to the +Y-axis direction) with screws 92. Of the pair of arms 84a and 84b, the fixing plate 86b extending to the right side is provided at an end portion on the rear side of the right arm 84b. The fixing plate 86b is fixed to the flat portion 42b on the rear side of the rectangular frame 42 of the frame 40 from the rear side (the direction from the −Y-axis direction to the +Y-axis direction) with the screws 92.

Therefore, the frame member 38 is welded to the second-fourth portion (fourth portion) 78 of the second bracket 36, and is fixed to the IP base 32 with the screws 92 from the rear side of the vehicle 10.

Note that a projection 52a protruding to the right side is formed on the left protrusion 50a of the frame 40. The projection 52a sandwiches the fixing plate 86a with the flat portion 42a of the rectangular frame 42. Therefore, forward and backward movement of the frame member 38 with respect to the IP base 32 is restricted. Further, a projection 52b protruding to the left side is formed on the right protrusion 50b of the frame 40. The projection 52b sandwiches the fixing plate 86b with the flat portion 42b of the rectangular frame 42. Therefore, forward and backward movement of the frame member 38 with respect to the IP base 32 is restricted.

Then, the screw 90 is disposed in the through hole 67 in the first-third portion 66 of the first bracket 34, the through hole 45 of the pedestal 44 of the IP base 32, and the screw hole 73 in the second-first portion 72 of the second bracket 36, and the screw 90 is screwed, whereby the first bracket 34, the IP base 32, and the second bracket 36 are fixed.

Therefore, the display assembly 20 fixed to the first bracket 34 is fixed to the fixing structure 30 including the IP base 32.

In the present embodiment, the normal direction of the first fixing surface 44a faces the cab side and faces upward with respect to the upper end of the display section 22. The normal direction of the second fixing surface 44b faces an opposite side to the normal direction of the first fixing surface 44a, that is, faces the front side and faces downward with respect to the horizontal direction. Therefore, in a case where the screw 90 is fastened, a tool such as a screwdriver does not interfere with the display assembly 20 or the like, and the screw 90 can be reliably fastened to screw hole 73 in the second-first portion 72 of the second bracket 36 through the through hole 67 in the first-third portion 66 of the first bracket 34 and the through hole 45 in the pedestal 44.

In the present embodiment, the first bracket 34 formed of a metal plate fixed to the back (back surface) 22b of the display section 22 and the structural components of the IP base 32 are fastened with the screws 90. The display assembly 20 according to the present embodiment is not simply engaged or the like, but is firmly fixed to the IP base 32. Since the component of the IP base 32 to be fastened with the screw 90 is the second bracket 36 formed of the metal plate, a holding force of the display assembly 20 with respect to the IP base 32 can be maintained high.

Then, it is assumed that, for example, a collision occurs from the rear side of the vehicle 10 according to the present embodiment, and an impact is input to the rear side of the vehicle 10. The impact is transmitted to the beam 16 extending in the right-left direction to the front portion of the vehicle 10 via the structure of the left-side member 12 and the right-side member 14 of the vehicle 10 and the like. Then, the impact is also transmitted from the beam 16 to the display assembly 20 through the IP base 32 and the first bracket 34. At this time, there is a possibility that the display assembly 20 will move toward the occupant side (rear side) due to inertia.

In the present embodiment, even in a case where an impact from the rear side of the vehicle 10 is input, the display assembly 20 fixed to the IP base 32 via the first bracket 34 is prevented from moving by the screw 90.

Therefore, the fixation of the IP base 32 to the beam 16 is prevented from being released, and the fixation of the pedestal 44 of the IP base 32 to the second-first portion 72 of the second bracket 36 and the fixation of the first-third portion 66 of the first bracket 34 to the pedestal 44 of the IP base 32 are prevented from being released. Therefore, the display assembly 20 is prevented from moving toward the occupant side with respect to the IP base 32.

Further, the fixing plate 86a of the frame member 38 is fixed to the flat portion 42a on the rear side of the rectangular frame 42 with the screw 92, and the fixing plate 86a of the frame member 38 is prevented from moving to the occupant side by the projection 52a. Further, the fixing plate 86b of the frame member 38 is fixed to the flat portion 42b on the rear side of the rectangular frame 42 with the screw 92, and the fixing plate 86b of the frame member 38 is prevented from moving to the occupant side by the projection 52b. Therefore, in a case where an impact from the rear side of the vehicle 10 is input and the impact is input to the second bracket 36 through the IP base 32, the fixing plates 86a and 86b of the frame member 38 prevent the back 22b of the display section 22 from being pushed out toward the occupant side.

Therefore, according to the present embodiment, it is possible to provide the fixing structure 30 of the display assembly 20 to the instrument panel base 32 of the vehicle 10, which can prevent the display assembly 20 from falling off toward the occupant side due to inertia in a case where the vehicle 10 collides from the rear side of the vehicle 10, for example, and an impact is applied to the vehicle 10, and the vehicle 10 including such a fixing structure 30.

In the above-described embodiment, an example in which the screw hole 73 in the second-first portion 72 of the second bracket 36 is formed as an internal thread has been described. For example, the screw hole 73 may be a through hole through which the screw portion of the screw 90 passes. In this case, the screw 90 may be formed as a bolt, and the screw portion of the screw 90 may be fastened to a nut (not illustrated). Therefore, the second-first portion (third portion) 72 of the second bracket 36 may be formed as an internal thread portion fixed to a base and the first bracket 34 with the external thread 90. An internal thread portion may be an internal thread or a nut of the screw hole 73 in the second bracket 34. Therefore, a simple nut may be used instead of the second bracket 36.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fixing structure of a display assembly to an instrument panel of a vehicle, the fixing structure comprising:
an instrument panel base of the vehicle as a vehicle frame;
one or more first brackets including:
a first portion to which a back surface of the display assembly having a display section whose screen is disposed toward an interior side of a cab of the vehicle is fixed, and
a second portion extending from the first portion to a front side of the vehicle and fastened to the instrument panel base with an external thread; and
an internal thread portion that fixes the one or more first brackets to the instrument panel base with the external thread.

2. The fixing structure according to claim 1, wherein,
in a state where the one or more first brackets is fastened to the instrument panel base with a fastening member, a head portion of the external thread faces the interior side of the cab.

3. The fixing structure according to claim 1, wherein
the first brackets are fixed to the instrument panel base while being separated from each other in a right-left direction of the vehicle.

4. The fixing structure according to claim 1, wherein
the instrument panel base includes an opening through which a back surface side of the display assembly is inserted.

5. The fixing structure according to claim 1, further comprising:
one or more second bracket including:
a third portion with the internal thread portion and
a fourth portion extending from the third portion to the front side of the vehicle; and
a frame member welded to the fourth portion and fixed to the instrument panel base with a screw from a rear side of the vehicle.

6. A vehicle comprising:
the fixing structure according to claim 1; and
a display assembly fixed by the fixing structure.
